(19) United States
(12) Patent Application Publication
(10) Pub. No.: US 2022/0034158 A1
(43) Pub. Date: Feb. 3, 2022

(54) INTERCHANGEABLE WINDOW AND DOOR COVERING SYSTEM AND ASSOCIATED METHODS OF USE AND MANUFACTURE

(71) Applicant: Inkable Arts, Inc., Orange, CA (US)

(72) Inventors: Cynthia Fascenelli Kirkeby, Orange, CA (US); David Anqi Chen, Fountain Valley, CA (US)

(73) Assignee: Inkable Arts, Inc., Orange, CA (US)

(21) Appl. No.: 17/390,988

(22) Filed: Aug. 1, 2021

Related U.S. Application Data
(60) Provisional application No. 63/059,989, filed on Aug. 1, 2020.
(60) Provisional application No. 63/144,148, filed on Feb. 1, 2021.

(51) Int. Cl. E06B 9/44

(52) U.S. Cl. CPC E06B 9/44

(57) ABSTRACT

An interchangeable covering system is disclosed for selectively covering an opening in a substantially vertically oriented surface. In at least one embodiment, the system provides a pair of side brackets positionable on either the opening or the surface proximal to the opening. A roller tube is rotatably and removably engagable between the side brackets, an outer surface of the roller tube defining an elongated, recessed attachment strip extending an entire length of the roller tube. A top edge of an at least one flexible panel, sized for covering the opening, is removably engagable with the attachment strip of the roller tube such that the top edge of the panel sits substantially flush with the outer surface of the roller tube. A panel rail is removably engagable with an opposing bottom edge of the panel. In use, the system facilitates the easy swapping of one panel for another.

### RELATED APPLICATIONS

This application claims priority and is entitled to the filing date of U.S. provisional application Ser. No. 63/059,989, filed on Aug. 1, 2020. This application also claims priority to U.S. provisional application Ser. No. 63/144,148, filed on Feb. 1, 2021. The contents of the aforementioned applications are incorporated herein by reference.

### BACKGROUND

The subject of this patent application relates generally to window and door coverings, and more particularly to a system of interchangeable components and associated methods of use and manufacture, with the components being configured for the easy insertion, exchange, and control of associated window and door covering materials to accommodate the needs of various openings and applications.

Applicant(s) hereby incorporate herein by reference any and all patents and published patent applications cited or referred to in this application.

By way of background, traditional window coverings include items such as shades, curtains, blinds, and shutters for example. The earliest roller shades are thought to have originated in Holland in the late 1700s, and by the mid-1800s they were in wide use throughout Europe and the United States. Such shades were traditionally made of opaque paper or fabric and were hand-painted with landscapes and later with stenciled borders. The first spring roller shade was patented in 1884 by Stewart Hartshorn (U.S. Patent No. 299,782). Four of the most prevalent control systems for shades include tie-ups, chain clutch systems, spring rollers, and motors.

Roller shades, as they exist today, are primarily designed such that the paper or fabric panels are attached when they are manufactured, such that they are not meant to be replaced during the life of the installation. This is not desirable for many reasons. If the users decide the material panel needs to be replaced, the entire roller shade assembly normally must be removed from the wall before a new mechanism with attached panels can be installed. Furthermore, roller shade assemblies are inherently difficult to install, with the task of leveling relatively larger roller shade units being especially problematic. Additionally, since the material panels are not meant to be exchanged, users are restricted in their ability to adjust their décor preferences, or advertising and branding needs in commercial situations. Thus, current solutions do not sufficiently address the needs of the user.

There are a few systems that have attempted to solve some of these issues with only partial success. Some such partial solutions use a simple spline system to attach the shade material to the tube, with manufacturers of such systems sometimes describing them as interchangeable; however these units are not easy for consumers to manipulate, and the splines are often failure points in systems once the material panel is fully extended. Another partial solution has addressed consumers' desire to switch the fabric by creating a two-part, U-shaped channel that locks together to join two segments of fabric, but it has been found to create a strain on the fabric that can cause it to rip, shear, or otherwise fail.

Accordingly, with respect to window and door coverings, Applicant has identified at least five areas of concern or interest, which should be taken into consideration, singly or in combination when developing a solution to the above-described problems in the art: 1) the ease of installation, 2) the ease of leveling, 3) the ease of roller tube disconnection and exchange, 4) the ability to easily attach a material panel on a roller tube (or rail) assembly, and 5) the ability to easily exchange a material panel to a roller tube (or rail) assembly for repairs, to adjust to seasonal demands, and to customize décor.

Window coverings are often used in order to provide a degree of privacy for occupants of buildings and other spaces, including vehicles. However, while traditional window coverings are able to block the view into buildings and other spaces, the trade-off is that they typically also block the view out of those buildings/spaces. As a result, occupants of such buildings/spaces are left with the choice of: a) closing curtains, blinds, or shutters in order to keep people from looking into their building/space while at the same time losing their view of the outside world; or b) leaving their window coverings open so they can maintain their view while also allowing strangers to look into their building/space as they walk by. Décor options in the window covering category is largely limited to the choice of materials and color. In certain cases, a manufacturer may offer printed imagery solutions, but the prints are usually done on opaque materials.

In academic and office window covering contexts, there has been a dramatic increase in school and workplace shooting incidents in recent years. In such events, the established protocol is to shelter in place, turn off the room lights, lock the doors, and move the students/employees to a corner of the room out of view of the windows (including any window located in the door). Individuals are also told to cover the window with paper, cardboard, fabric, or other opaque materials. This practice causes a primary problem: the occupants of the room can no longer see if the shooter is nearby. There have also been times when innocent individuals have been trapped in hallways, but can't be let into a secured room because occupants who are in lock-down can't see if they are friend or foe. They have to assume that the individuals outside the door are armed and therefore, these individuals are left outside at risk from the shooter for lack of a safe place to hide.

There are similar issues that arise in residential situations when doors have inset windows or sidelights. Dangerous strangers can see into a home and the occupant is left with no easy way to protect their privacy and their safety. In businesses, especially coworking and semi-industrial complexes, there are frequently window coverings of some sort in place, but the doors to the units are often glass panels with no easy way to ensure the occupant's privacy and safety. A better solution is needed for privacy within educational, residential, and commercial buildings that can offer an added degree of safety.

In commercial window covering contexts, there is also a serious need for a privacy solution that can protect sensitive business materials from visual hacking. Today's offices are increasingly reducing the square footage per office. As an example, coworking/shared office spaces for a single person can average a mere 36 square feet. To accommodate this space reduction without triggering claustrophobic reactions to the small spaces, coworking spaces and offices typically provide glass-walled offices to make the spaces feel larger than they actually are. Although the transparent walls make these small spaces more comfortable to work in, they leave the occupants and all of their sensitive business assets exposed. To solve the problem, the occupants often use partially frosted window appliques, which keep people from looking in, but also blocks the occupant from seeing out. Thus, current solutions are not sufficient.

Another type of breach of privacy that is possible in these transparent workspaces is covert sound surveillance by visual microphones as seen in recent MIT research. By taking high-speed video of items in a room, even through a pane of sound-proof glass, minute movements of the item (such as the leaves of a plant) can be used to recreate the sound the object was exposed to. A visual barrier is therefore needed to obscure the interior and limit this form of covert intrusion.

Stickers and window wraps are also becoming more prevalent in recent years—more so for advertising purposes rather than privacy. However, it has been found that such stickers and window wraps are less than ideal when it comes to providing privacy. Specifically, given that these types of products are adhered directly to a window, it has been found that they tend to lose their ability to obscure an interior space when the viewer (exterior to the space/window) uses a cell phone or spy camera positioned relatively close (within a few inches) to the sticker/window wrap. Thus, the privacy benefits can be easily undermined by a simple camera that is able to focus past such window applications.

Accordingly, when it comes to window coverings, and in some cases door coverings, for educational, residential, and business buildings, a lightweight, easy to install, one-way vision covering is needed that protects an occupant's privacy and adds a level of safety. Glare control and customizable décor would be welcome added benefits.

Aspects of the present invention fulfill these needs and provide further related advantages as described in the following summary.

It should be noted that the above background description includes information that may be useful in understanding aspects of the present invention. It is not an admission that any of the information provided herein is prior art or relevant to the presently claimed invention, or that any publication specifically or implicitly referenced is prior art.

### SUMMARY

Aspects of the present invention teach certain benefits in construction and use which give rise to the exemplary advantages described below.

The present invention solves the problems described above by providing an interchangeable covering system positionable for selectively covering an opening in a substantially vertically oriented surface. In at least one embodiment, the system provides a pair of side brackets positionable on either the opening or the surface proximal to the opening. A pair of side brackets are removably engagable with opposing ends of the mounting bar. A roller tube is rotatably and removably engagable between the side brackets, an outer surface of the roller tube defining an elongated, recessed attachment strip extending an entire length of the roller tube. A top edge of an at least one flexible panel, sized for covering the opening, is removably engagable with the attachment strip of the roller tube such that the top edge of the panel sits substantially flush with the outer surface of the roller tube. A panel rail is removably engagable with an opposing bottom edge of the panel.

In at least one alternate embodiment, the system provides an at least one flexible panel sized for covering the opening. A first panel rail is removably engagable with a top edge of the panel and configured for being mounted on either the opening or the surface proximal to the opening. A second panel rail is removably engagable with an opposing bottom edge of the panel. The first panel rail provides an at least one first attachment portion positioned and configured for removable engagement with a corresponding at least one second attachment portion provided by the second panel rail, wherein upon the second panel rail being folded up against the first panel rail, the first and second attachment portions removably secure the first and second panel rails together.

Thus, in use, the system is capable of facilitating the easy swapping of one panel for another, among other benefits, as discussed further herein. Other features and advantages of aspects of the present invention will become apparent from the following more detailed description, taken in conjunction with the accompanying drawings, which illustrate, by way of example, the principles of aspects of the invention.

### BRIEF DESCRIPTION OF THE DRAWINGS

The accompanying drawings illustrate aspects of the present invention. In such drawings:

FIG. 1 is a perspective view of an exemplary interchangeable covering system, in accordance with at least one embodiment;

FIG. 2 is an exploded view thereof, with a panel of the system omitted for clarity purposes;

FIG. 3 is an exploded view of an exemplary mounting bracket of the system, in accordance with at least one embodiment;

FIG. 4 is an exploded view of an exemplary disconnect sleeve and an exemplary braking mechanism of the system, in accordance with at least one embodiment;

FIG. 5 is a partial perspective view of an exemplary roller tube and an exemplary panel of the system, in accordance with at least one embodiment;

FIG. 6 is a side elevational view of a further exemplary roller tube and a further exemplary panel of the system, in accordance with at least one embodiment;

FIG. 7 is an exploded view of a further exemplary interchangeable covering system, in accordance with at least one embodiment, with a panel of the system omitted for clarity purposes;

FIG. 8 is an exploded view of a still further exemplary interchangeable covering system, in accordance with at least one embodiment, with a panel of the system omitted for clarity purposes;

FIG. 9 is an exploded view of an exemplary motor assembly of the system, in accordance with at least one embodiment;

FIG. 10 is an exploded view of a still further exemplary interchangeable covering system, in accordance with at least one embodiment;

FIG. 11 is an exploded view of a still further exemplary interchangeable covering system, in accordance with at least one embodiment;

FIG. 12 is a further perspective view thereof;

FIG. 13 is an exploded view of an exemplary end cap of an exemplary panel rail of the system, in accordance with at least one embodiment;

FIG. 14 is a perspective view of a still further exemplary interchangeable covering system, in accordance with at least one embodiment;

FIG. 15 is a perspective view of a still further exemplary interchangeable covering system, in accordance with at least one embodiment, exploded from an exemplary opening and corresponding surface; and

FIG. 16 is a perspective view of an exemplary release tool of the system, in accordance with at least one embodiment.

The above described drawing figures illustrate aspects of the invention in at least one of its exemplary embodiments, which are further defined in detail in the following description. Features, elements, and aspects of the invention that are referenced by the same numerals in different figures represent the same, equivalent, or similar features, elements, or aspects, in accordance with one or more embodiments.

### DETAILED DESCRIPTION

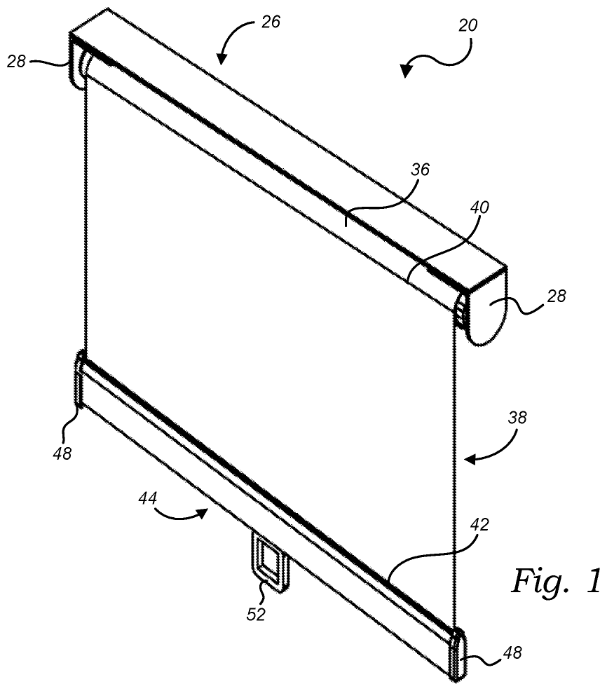

Turning now to FIG. 1, there is shown a perspective view of an exemplary embodiment of an interchangeable covering system 20 configured to be positioned in, or in front of, a window, a door, a transparent or translucent solid panel, or a structural opening (hereinafter generally referred to as an “opening” 22 for simplicity purposes) of a substantially vertically oriented surface 24 of a building, room, vehicle, or other space where an opening 22 might be positioned (hereinafter generally referred to as a “space” for simplicity purposes). Although the most common installation location for the system 20 is in an interior space, in at least one alternate embodiment, the system 20 may be configured to be installed in an exterior space. Thus, the system 20 should not be read as being limited to one type of space or another.

With continued reference to FIG. 1, in at least one embodiment, the system 20 provides a mounting bar 26 configured for being mounted proximal to the opening 22 in a substantially horizontal orientation. The system 20 further provides an at least one pair of side brackets 28 engaged with opposing ends 30 of the at least one mounting bar 26. In at least one such embodiment, each of the side brackets 28 provides an at least one mounting tab 32 positioned and configured for being slidably engaged with a corresponding mounting slot 34 provided by the mounting bar 26, thereby allowing the side brackets 28 to be removably engagable with the mounting bar 26. In at least one alternate embodiment, the mounting bar 26 is omitted, such that the side brackets 28 are configured for being mounted proximal to the opening 22. Additionally, an at least one roller tube 36 is rotatably engaged between each of the at least one pair of side brackets 28. An at least one flexible panel 38 is sized for covering the opening 22 and engaged with each roller tube 36 along a top edge 40 of the panel 38, with an opposing bottom edge 42 of the panel 38 being engaged with a panel rail 44. The panel 38 may be constructed out of paper, plastic, vinyl, rubber, fabric, metal, privacy mesh (similar to the materials described in WO2020/076687 to Kirkeby et al.) or any other material (or combinations of materials), now known or later developed, capable of being utilized by the system 20 as a panel 38 for selectively covering the opening 22. In at least one embodiment, the top edge 40 of the panel 38 is removably engagable with the roller tube 36. In at least one such embodiment, the at least one roller tube 36 provides an attachment strip 46 configured for removable engagement with the top edge 40 of the panel 38. In at least one embodiment, the attachment strip 46 extends an entire length of the roller tube 36; however, in further embodiments, the attachment strip 46 may extend less than the entire length of the roller tube 36. In further such embodiments, any other mechanism or technique (now known or later developed) capable of creating a removable engagement between the roller tube 36 and the top edge 40 of the panel 38 may be substituted. In at least one alternate embodiment, the top edge 40 of the panel 38 is permanently engaged with the roller tube 36. In at least one embodiment, the panel rail 44 provides a pair of end caps 48 engaged with opposing ends 50 of the panel rail 44, along with a pull tab 52 positioned and configured for assisting in manually rolling and unrolling the at least one panel 38 relative to the roller tube 36. In at least one embodiment, the system 20 is configured such that the at least one panel 38 is wound around the roller tube 36 to lie either in its closest orientation to the inside of the covered space or its furthest, at the preference of the user. At the outset, it should be noted that the size, shape, and dimensions of each of the components shown and described herein are merely exemplary and shown for illustrative purposes. As such, in further embodiments, each of the components of the system 20 may take on any other sizes, shapes, dimensions, quantities and/or relative positions, now known or later developed, so long as the system 20 is capable of substantially carrying out the functionality described herein.

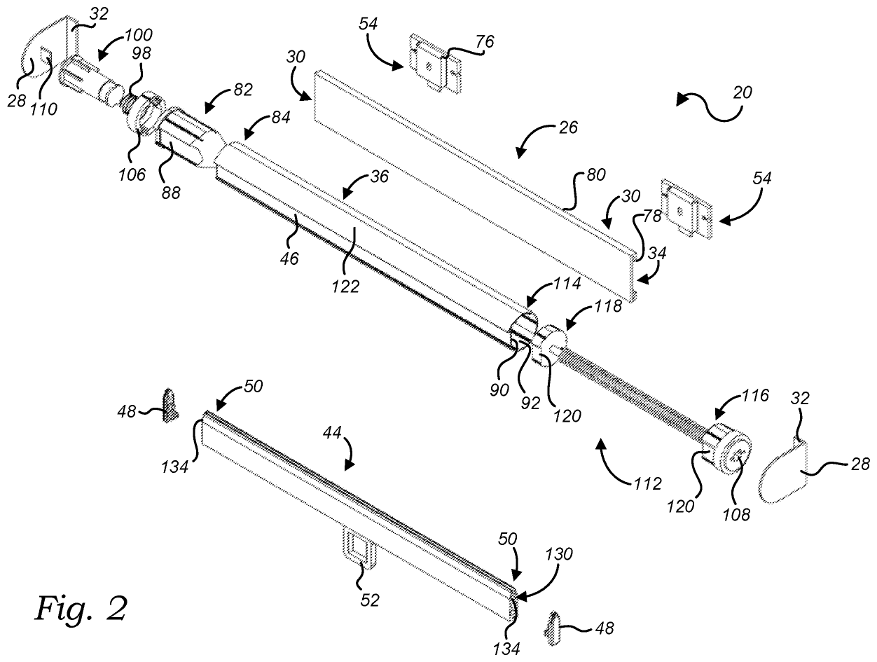

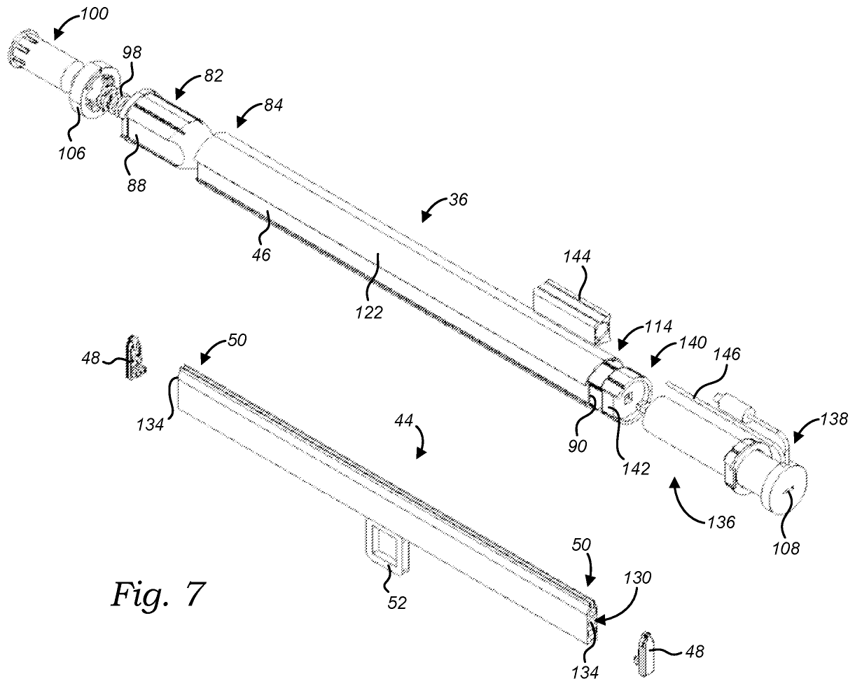

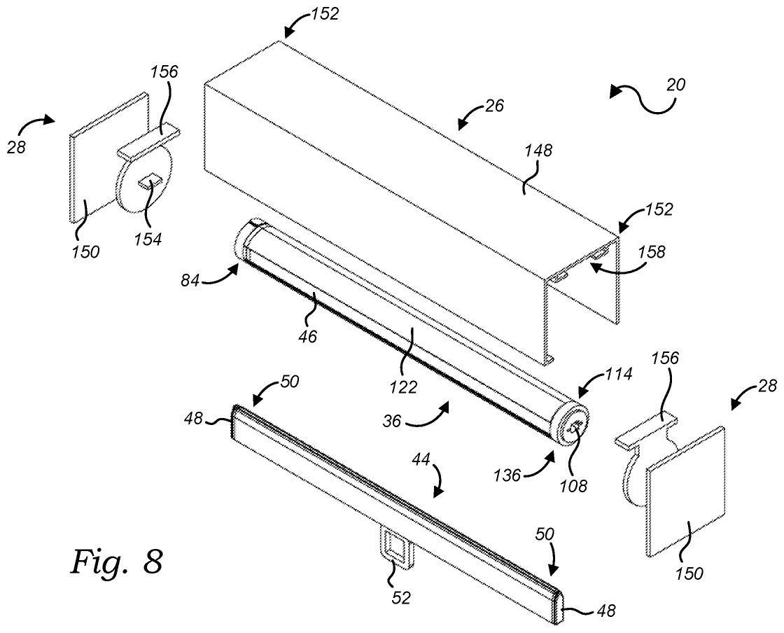

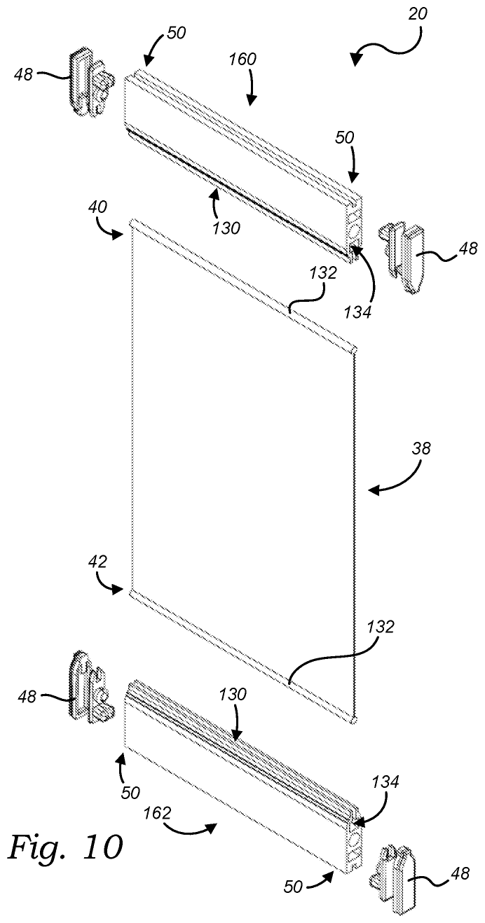

To further illustrate the functionality of the system 20 and how the components of the system 20 may be assembled and configured, further exemplary embodiments are illustrated in FIG. 2 (wherein the system 20 is configured as a spring roller shade assembly), FIG. 7 (wherein the system 20 is configured as a motorized shade assembly), FIG. 8 (wherein the system 20 is configured as a motor assembly with a cassette), and FIGS. 10-12 (wherein the system 20 is configured as a fold and latch rail assembly), each of which are discussed in detail below. Once again, these various embodiments are intended to be non-limiting examples provided for illustrative purposes only in order to facilitate a more complete understanding of representative embodiments now contemplated. These examples are intended to be a mere subset of all possible configurations and contexts in which the system 20 may be utilized. Thus, these examples should not be construed to limit any of the embodiments described in the present specification.

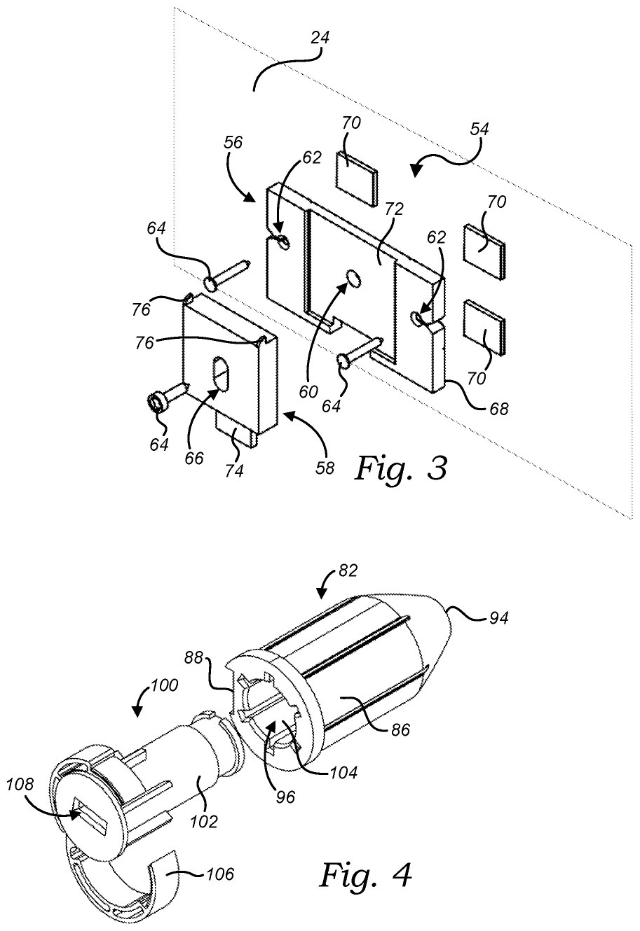

Turning first to the embodiment depicted in FIG. 2 (wherein the system 20 is configured as a spring roller shade assembly), in at least one such embodiment, the mounting bar 26 and side brackets 28 are mounted to a substantially vertical surface 24 (such as a door or wall, for example) or, alternatively, to the opening 22 itself (where the opening 22 contains a surface such as a window, for example). In at least one embodiment, the mounting bar 26 and side brackets 28 are mounted to the surface 24 using an at least one mounting bracket 54. In at least one embodiment, as illustrated in FIG. 3, each of the at least one mounting bracket 54 provides a backplate 56 and a mounting portion 58. In at least one embodiment, the mounting portion 58 is removably engagable with the backplate 56; however, in at least one alternate embodiment, the mounting portion 58 is permanently engaged or otherwise integral with the backplate 56. In at least one embodiment, the backplate 56 provides an at least one primary mounting hole 60, along with an at least one secondary mounting hole 62, with each of the primary and secondary mounting holes 60 and 62 extending through the backplate 56 for allowing a fastener 64 (such as a screw or nail, for example) to extend therethrough and into the surface 24, thereby securing the backplate 56 to the surface 24. In at least one such embodiment, the at least one primary mounting hole 60 is positioned substantially at a center point of the backplate 56, such that the backplate 56 is first secured to the surface 24 via the primary mounting hole 60 so as to enable the backplate 56 to be leveled prior to further securing the backplate 56 to the surface 24 via the at least one secondary mounting hole 62. In at least one embodiment, the mounting portion 58 provides a corresponding at least one engagement hole 66 positioned and configured for aligning with the at least one primary mounting hole 60 when the mounting portion 58 is engaged with the backplate 56, thereby allowing the fastener 64 to extend through each of the engagement hole 66 and primary mounting hole 60 when securing the backplate 56 to the surface 24 which, in turn, secures the mounting portion 58 to the backplate 56. In at least one further embodiment, a rear surface 68 of the backplate 56 provides an at least one temporary fastener pad 70 (such as an adhesive pad, for example) positioned and configured for temporarily securing the backplate 56 to the surface 24 after the backplate 56 has been leveled, prior to being secured via the at least one secondary mounting hole 62. In at least one embodiment, where the mounting portion 58 is removably engagable with the backplate 56, the backplate 56 provides a recess 72 sized and configured for receiving the mounting portion 58 therewithin. In at least one such embodiment, the mounting portion 58 is frictionally engagable with the recess 72, with the mounting portion 58 further providing a release tab 74 positioned and configured for assisting in manually disengaging the mounting portion 58 from the recess 72; however, in further embodiments, any other mechanism or technique (now known or later developed) for enabling a removable engagement between the mounting portion 58 and recess 72 may be substituted.

In at least one embodiment, as illustrated in FIGS. 2 and 3, the mounting portion 58 provides an at least one engagement tab 76 positioned and configured for removable engagement with a corresponding at least one engagement receptacle 78 positioned on a rear surface 80 of the mounting bar 26, thereby allowing the mounting bar 26 (along with the side brackets 28, roller tube 36 and panel 38) to be removably engaged with the at least one mounting bracket 54 and, in turn, the substantially vertical surface 24. In at least one embodiment, the at least one engagement receptacle 78 is an aperture positioned and configured for receiving the corresponding at least one engagement tab 76 therethrough. In at least one alternate embodiment, the at least one engagement receptacle 78 is a slot positioned and configured for receiving the corresponding at least one engagement tab 76 therewithin. In still further embodiments, any other mechanism or technique (now known or later developed) for enabling a removable engagement between the mounting portion 58 and mounting bar 26 may be substituted.

With continued reference to FIG. 2, in at least one embodiment, a first one of the side brackets 28 provides a disconnect sleeve 82 removably insertable within a first end 84 of the roller tube 36, thereby allowing the roller tube 36 to be removably engaged with the first one of the side brackets 28. In at least one such embodiment, as illustrated in FIG. 4, an outer surface 86 of the disconnect sleeve 82 is configured for being frictionally engaged within the first end 84 of the roller tube 36. Additionally, in at least one embodiment, the outer surface 86 of the disconnect sleeve 82 provides an elongated alignment slot 88 positioned and configured for slidably receiving a corresponding alignment rail 90 provided on an inner surface 92 of the roller tube 36, thereby allowing the disconnect sleeve 82 and the roller tube 36 to rotate in unison relative to the side brackets 28. In further embodiments, any other mechanism or technique (now known or later developed) for allowing the disconnect sleeve 82 and the roller tube 36 to rotate in unison relative to the side brackets 28 may be substituted. In at least one embodiment, the disconnect sleeve 82 provides a release button 94 positioned and configured for disengaging the disconnect sleeve 82 from the first end 84 of the roller tube 36. In at least one embodiment, the disconnect sleeve 82 defines an interior space 96 sized and configured for receiving a release spring 98 (FIG. 2) therewithin. In at least one embodiment, the interior space 96 is further sized and configured for receiving a brake mechanism 100, such that the release spring 98 is held within the interior space 96 by the brake mechanism 100. In such embodiments, the brake mechanism 100 is positioned and configured for rotationally locking the roller tube 36 relative to the side brackets 28. In at least one such embodiment, as illustrated in FIG. 4, an outer surface 102 of the brake mechanism 100 is keyed for mating with an inner surface 104 of the disconnect sleeve 82, thereby allowing the brake mechanism 100 and the disconnect sleeve 82 (along with the roller tube 36) to rotate in unison. Additionally, in at least one embodiment, the brake mechanism 100 provides a locking ring 106 configured for selectively retaining the brake mechanism 100 within the disconnect sleeve 82. In at least one embodiment, the brake mechanism 100 further provides a bracket slot 108 positioned and configured for removably receiving a corresponding bracket tab 110 provided by the first one of the side brackets 28 (FIG. 2).

With continued reference to FIG. 2, in at least one embodiment, a second one of the side brackets 28 provides a spring drive assembly 112 engaged with an opposing second end 114 of the roller tube 36 and configured for rotating the roller tube 36 in a direction to roll the panel 38 up onto the roller tube 36. In at least one such embodiment, a first end 116 of the spring drive assembly 112 provides a bracket slot 108 positioned and configured for removably receiving a corresponding bracket tab 110 provided by the second one of the side brackets 28. Additionally, in at least one embodiment, an opposing second end 118 of the spring drive assembly 112 provides an elongated alignment slot 120 positioned and configured for slidably receiving the corresponding alignment rail 90 provided on the inner surface 92 of the roller tube 36, thereby allowing the spring drive assembly 112 and the roller tube 36 to rotate in unison relative to the side brackets 28. In at least one further such embodiment, the first end 116 of the spring drive assembly 112 also provides the elongated alignment slot 120 positioned and configured for slidably receiving the corresponding alignment rail 90 provided on the inner surface 92 of the roller tube 36. In further embodiments, any other mechanism or technique (now known or later developed) for allowing the spring drive assembly 112 and the roller tube 36 to rotate in unison relative to the side brackets 28 may be substituted.

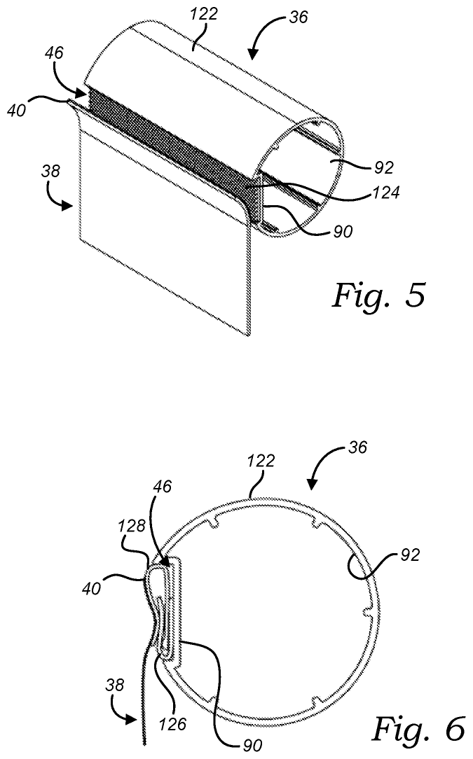

In at least one embodiment, as illustrated in FIG. 5, the alignment rail 90 provided on the inner surface 92 of the roller tube 36 forms the elongated, substantially flat attachment strip 46 on the opposing outer surface 122 of the roller tube 36; the attachment strip 46 positioned and configured for removable engagement with the top edge 40 of the panel 38. In at least one such embodiment, roller tube 36 is an extruded part, such that the alignment rail 90 and attachment strip 46 are integral with the roller tube 36. Removable engagement between the attachment strip 46 and the top edge 40 of the panel 38 may be achieved using any removable engagement mechanisms now known or later developed—including but in no way limited to hook-and-loop fasteners 124, dual lock fasteners, magnets, adhesive strips, snaps, etc. In at least one further embodiment, as illustrated in FIG. 6, the attachment strip 46 provides an at least one roller clip 126, while the top edge 40 of the panel 38 provides a corresponding at least one panel clip 128 positioned and configured for removable engagement with the at least one roller clip 126. In at least one embodiment, the attachment strip 46 is recessed into the outer surface 122 of the roller tube 36, such that when the top edge 40 of the panel 38 is removably engaged therewith, the joined engagement mechanisms sit within the recess and the top edge 40 of the panel 38 sits substantially flush with the outer surface 122 of the roller tube 36, thereby eliminating or at least significantly reducing any bulging along the roller tube 36. Furthermore, the recessed attachment strip 46 assists in correctly aligning the top edge 40 of the panel 38 therewith, thereby better ensuring proper installation of the panel 38. The recessed attachment strip 46 also reduces the chances of the panel 38 rolling up onto the roller tube 36 unevenly/crooked.

Referring again to FIG. 2 and as mentioned above, in at least one embodiment, the bottom edge 42 of the panel 38 is engaged with a panel rail 44. In at least one such embodiment, the panel rail 44 provides a lengthwise rail slot 120 that terminates at opposing ends 50 of the panel rail 44 and is configured for slidably receiving a corresponding edge tab 132 provided by the bottom edge 42 of the panel 38. In such embodiments, the edge tab 132 is insertable into the rail slot 120 via one of the terminal ends 50 of the panel rail 44. In at least one such embodiment, the edge tab 132 has a thickness or diameter that is relatively larger than a thickness of the panel 38 itself, thereby assisting with the insertion of the edge tab 132 into the rail slot 120 and being retained therewithin. Additionally, in at least one embodiment, each of the opposing ends 50 of the panel rail 44 provides a removably engagable end cap 48 configured for obstructing the terminal ends 134 of the rail slot 120 so as to prevent the edge tab 132 from unintentional disengagement from the rail slot 120. In further embodiments, any other mechanism or technique (now known or later developed) for enabling a removable engagement between the bottom edge 42 of the panel 38 and the panel rail 44 may be substituted. In at least one alternate embodiment, the panel rail 44 is permanently engaged or otherwise integral with the bottom edge 42 of the panel 38.

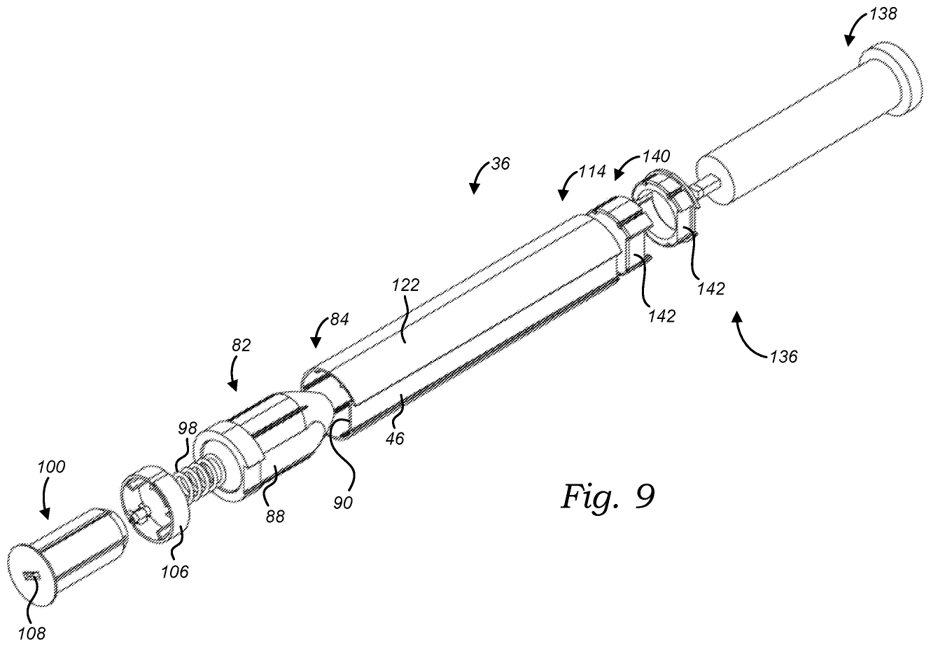

Turning next to the embodiment depicted in FIG. 7 (wherein the system 20 is configured as a motorized shade assembly), in at least one such embodiment, the system 20 incorporates many of the same components as shown and described in the various spring roller shade assembly embodiments discussed above. However, in such embodiments, a motor assembly 136 (FIG. 9) is substituted in place of the spring drive assembly 112, such that a first end 138 of the motor assembly 136 provides a bracket slot 108 positioned and configured for removably receiving the corresponding bracket tab 110 provided by the second one of the side brackets 28, while an opposing second end 140 of the motor assembly 136 provides an elongated alignment slot 142 positioned and configured for slidably receiving the corresponding alignment rail 90 provided on the inner surface 92 of the roller tube 36, thereby allowing the second end 140 of the motor assembly 136 and the roller tube 36 to rotate in unison relative to the side brackets 28. Additionally, in at least one such embodiment, the system 20 provides an at least one wire caddy 144 positioned and configured for storing any excess wiring 146.

Turning next to the embodiment depicted in FIG. 8 (wherein the system 20 is configured as a motor assembly with a cassette), in at least one such embodiment, the mounting bar 26 is configured as a cassette providing a cassette casing 148 sized for housing the motor assembly 136. Additionally, in at least one embodiment, the cassette casing 148 is mounted to the substantially vertical surface 24 using at least one mounting bracket 54. In at least one embodiment, the pair of side brackets 28 are configured as a pair of cassette end panels 150 engaged with opposing ends 152 of the cassette casing 148, with the motor assembly 136 engaged between the cassette end panels 150. In at least one embodiment, opposing ends 138 and 140 of the motor assembly 136 each provides a bracket slot 108 positioned and configured for removably receiving a corresponding end panel tab 154 provided by each of the cassette end panels 150. Additionally, in at least one embodiment, each of the cassette end panels 150 provides an at least one mounting tab 156 positioned and configured for being slidably engaged with a corresponding mounting slot 158 provided by the cassette casing 148, thereby allowing the cassette end panels 150 to be removably engagable with the cassette casing 148.

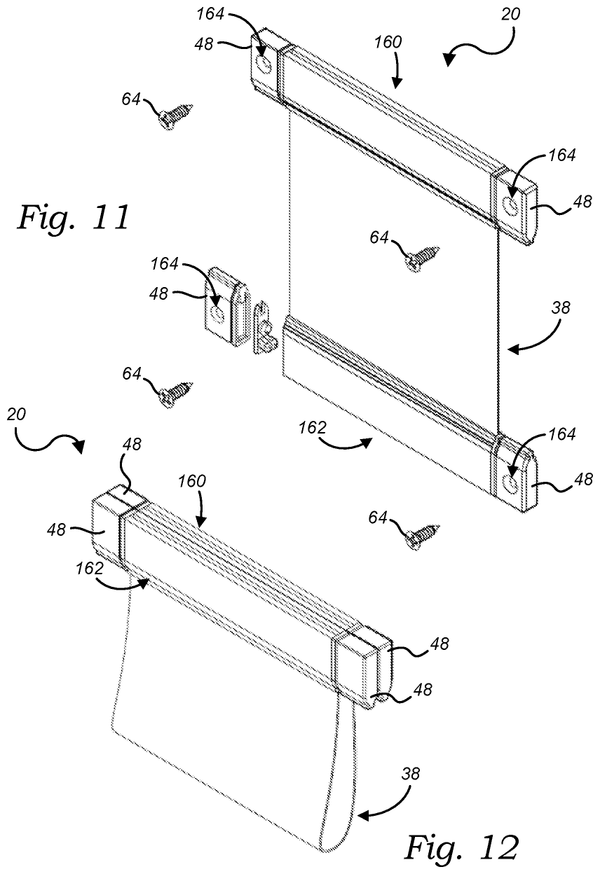

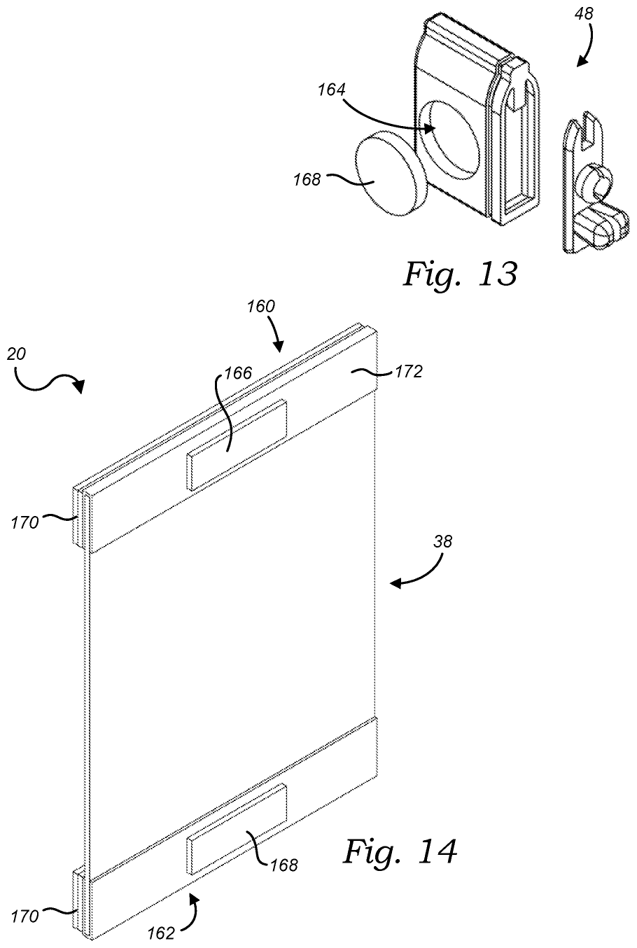

Turning next to the embodiment depicted in FIGS. 10-12 (wherein the system 20 is configured as a fold and latch rail assembly), in at least one such embodiment, the system 20 provides a first panel rail 160 removably engagable with the top edge 40 of the panel 38, and a second panel rail 162 removably engagable with the bottom edge 42 of the panel 38, with the removable engagement therebetween similar to that described above in connection with other embodiments of the system 20. In at least one embodiment, as illustrated in FIG. 10, the first panel rail 160 is mounted to the substantially vertical surface 24 (or alternatively to the opening 22 itself, where the opening 22 contains a surface such as a window, for example) using at least one mounting bracket 54. In at least one alternate embodiment, as illustrated in FIG. 11, each of the opposing end caps 48 are removably engagable with the first panel rail 160 provides an at least one end cap mounting hole 164 extending substantially transversely through the end cap 48 for allowing a fastener 64 to extend therethrough and into the surface 24, thereby securing the end cap 48 (and, in turn, the top edge 40 of the panel 38) to the surface 24. In at least one further embodiment, each of the opposing end caps 48 are removably engagable with the second panel rail 162 also provides an at least one end cap mounting hole 164 extending substantially transversely through the end cap 48 for allowing a fastener 64 to extend therethrough and into the surface 24, thereby securing the end cap 48 (and, in turn, the bottom edge 42 of the panel 38) to the surface 24. In at least one embodiment, as illustrated in FIGS. 12 and 13, each of the end caps 48 of the first panel rail 160 provide first attachment portions 166 that are positioned and configured for removable engagement with corresponding second attachment portions 168 provided by each of the end caps 48 of the second panel rail 162. Accordingly, upon the second panel rail 162 being folded up against the first panel rail 160, the first and second attachment portions 166 and 168 removably secure the first and second panel rails 160 and 162 together. In at least one such embodiment, the first and second attachment portions 166 and 168 are magnets; however, in alternate such embodiments, the first and second attachment portions 166 and 168 may utilize any other removable engagement mechanisms now known or later developed—including but in no way limited to hook-and-loop fasteners, dual lock fasteners, adhesive strips, snaps, etc. Additionally, in at least one alternate embodiment, the first attachment portion 166 is positioned elsewhere on the first panel rail 160, while the second attachment portion 168 is positioned in a corresponding location on the second panel rail 162.

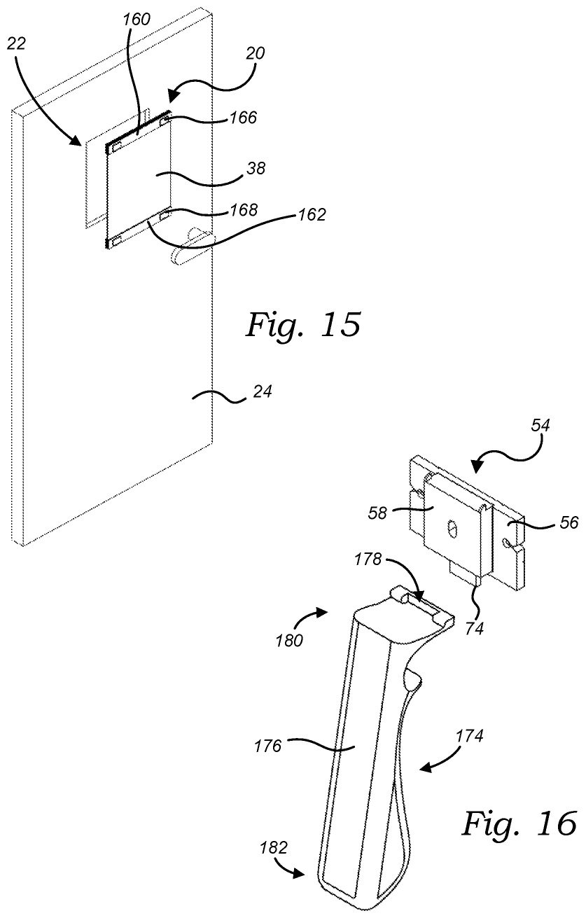

In at least one still further such embodiment, as illustrated in FIGS. 14 and 15, the first and second panel rails 160 and 162 are each constructed out of an at least one mounting strip 170 engaged with the respective top and bottom edges 40 and 42 of the panel 38. In at least one such embodiment, the mounting strips 170 are secured to the substantially vertical surface 24 using any removable engagement mechanisms now known or later developed—including but in no way limited to hook-and-loop fasteners, dual lock fasteners, magnets, adhesive strips, snaps, etc. It should be noted that the specific size, shape, dimensions and relative positions of the mounting strips 170, along with the first and second attachment portions 166 and 168, may vary in further embodiments, so long as the system 20 is capable of substantially carrying out the functionality described herein. In at least one such further embodiment, at least one mounting strip 170 attaches to the surface 24 and has one side (surface 24 facing) that is covered in whole or in part with an adhesive material, or other adherent, with the respective first or second attachment portion 166 or 168 positioned on the opposing side. A further at least one mounting strip 170 attaches to the panel 38 and is engineered similarly and applied in reverse, with the adhesive facing and attaching to the panel 38 and the respective first or second attachment portion 166 or 168 facing the at least one mounting strip 170 that attaches to the surface 24, in accordance with at least one embodiment. In at least one still further embodiment, the adhesive material on the at least one mounting strip 170 that attaches to the panel 38 has a backing material 172 that solves the problem of adhesive leaking or migrating through the panel 38 where it would potentially create an unpleasant experience with the system 20, both visually and tactilely, in accordance with at least one embodiment. Additionally, in such embodiments, the backing material 172 prevents degradation of the adhesive from exposure to moisture and oxygen in the environment. This reduces the risk of delamination of the mounting strip 170 from the panel 38. In at least one further such embodiment, as illustrated in FIG. 14, the backing material 172 wraps around each of the top and bottom edges 40 and 42 of the panel 38.

As described above, in at least one embodiment, the mounting portion 58 of the at least one mounting bracket 54 is frictionally engagable with the recess 72 of the backplate 56, with the mounting portion 58 further providing a release tab 74 positioned and configured for assisting in manually disengaging the mounting portion 58 from the recess 72. In at least one such embodiment, as illustrated in FIG. 16, the system 20 provides a release tool 174 configured for assisting in accessing and manually actuating the release tab 74. In at least one embodiment, the release tool 174 provides an elongated handle portion 176 along with a tab release notch 178 positioned at a distal end 180 of the handle portion 176; the tab release notch 178 sized for approximating the dimensions of the release tab 74. Accordingly, in use, with the tab release notch 178 positioned between the release tab 74 and the surface 24 on which the mounting bracket 54 is secured, an opposing proximal end 182 of the handle portion 176 is pivoted toward the surface 24, thereby causing the tab release notch 178 to contact the release tab 74 and disengage the mounting portion 58 from the recess 72 of the backplate 56.

Accordingly, in at least one embodiment, the system 20 is capable of providing a solution for each of the previously stated areas of concern—i.e., 1) ease of installation, 2) ease of leveling, 3) ease of roller tube 36 disconnection and exchange, 4) the ability to easily attach the panel 38 on the roller tube 36 (or panel rails 44), and 5) the ability to easily change out the panel 38 for repairs, to adjust to seasonal demands, or to customize décor—by providing an interchangeable set of components that can be configured to solve unique door and window covering situations faced by residential and commercial facilities.

Aspects of the present specification may also be described as the following embodiments:

1. An interchangeable covering system positionable for selectively covering an opening in a substantially vertically oriented surface, the system comprising: a pair of side brackets positionable on either the opening or the surface proximal to the opening; a roller tube rotatably and removably engagable between the side brackets, an outer surface of the roller tube defining an elongated, recessed attachment strip extending an entire length of the roller tube; an at least one flexible panel sized for covering the opening, a top edge of the panel removably engagable with the attachment strip of the roller tube such that the top edge of the panel sits substantially flush with the outer surface of the roller tube; and a panel rail engaged with an opposing bottom edge of the panel; whereby, the system is capable of facilitating the easy swapping of one panel for another.

2. The interchangeable covering system according to embodiment 1, wherein the attachment strip forms an elongated alignment rail on an opposing inner surface of the roller tube, the alignment rail extending the entire length of the roller tube.

3. The interchangeable covering system according to embodiments 1-2, wherein the side brackets are configured for being removably engagable with opposing ends of a substantially horizontally oriented mounting bar, the mounting bar configured for being mounted on either the opening or the surface proximal to the opening in a substantially horizontal orientation.

4. The interchangeable covering system according to embodiments 1-3, wherein the at least one panel is constructed out of at least one of paper, plastic, vinyl, rubber, fabric, metal, and privacy mesh.

5. The interchangeable covering system according to embodiments 1-4, wherein the panel rail provides a pull tab positioned and configured for assisting in manually rolling and unrolling the at least one panel relative to the roller tube.

6. The interchangeable covering system according to embodiments 1-5, further comprising an at least one mounting bracket engaged with the mounting bar and configured for securing the mounting bar to the surface, each of the at least one mounting bracket comprising: a mounting portion providing an at least one engagement tab positioned and configured for removable engagement with a corresponding at least one engagement receptacle positioned on a rear surface of the mounting bar; and a backplate providing a recess sized and configured for removably receiving the mounting portion therewithin, the backplate configured for being secured to the surface via an at least one fastener.

7. The interchangeable covering system according to embodiments 1-6, wherein the at least one engagement receptacle is an aperture positioned and configured for receiving the corresponding at least one engagement tab therethrough.

8. The interchangeable covering system according to embodiments 1-7, wherein the at least one engagement receptacle is a slot positioned and configured for receiving the corresponding at least one engagement tab therewithin.

9. The interchangeable covering system according to embodiments 1-8, wherein the backplate of the at least one mounting bracket further provides: an at least one primary mounting hole positioned substantially at a center point of the backplate and extending through the backplate for allowing the at least one fastener to extend therethrough and into the surface, thereby securing the backplate to the surface; and an at least one secondary mounting hole positioned for further securing the backplate to the surface, the at least one secondary mounting hold extending through the backplate for allowing a further at least one fastener to extend therethrough and into the surface; whereby, the backplate is first secured to the surface via the at least one primary mounting hole so as to enable the backplate to be leveled prior to further securing the backplate to the surface via the at least one secondary mounting hole.

10. The interchangeable covering system according to embodiments 1-9, wherein the mounting portion provides a corresponding at least one engagement hole positioned and configured for aligning with the at least one primary mounting hole when the mounting portion is engaged with the backplate, thereby allowing the corresponding at least one fastener to extend through each of the engagement hole and primary mounting hole when securing the backplate to the surface.

11. The interchangeable covering system according to embodiments 1-10, wherein a rear surface of the backplate provides an at least one temporary fastener pad positioned and configured for temporarily securing the backplate to the surface after the backplate has been leveled, prior to being secured via the at least one secondary mounting hole.

12. The interchangeable covering system according to embodiments 1-11, wherein: the mounting portion is frictionally engagable with the recess; and the mounting portion further provides a release tab positioned and configured for assisting in manually disengaging the mounting portion from the recess.

13. The interchangeable covering system according to embodiments 1-12, further comprising a release tool configured for assisting in accessing and manually actuating the release tab, the release tool comprising: an elongated handle portion; and a tab release notch positioned at a distal end of the handle portion, the tab release notch sized for approximating the dimensions of the release tab; whereby, in use, with the tab release notch positioned between the release tab and the surface on which the mounting bracket is secured, an opposing proximal end of the handle portion is pivoted toward the surface, thereby causing the tab release notch to contact the release tab and disengage the mounting portion from the recess of the backplate.

14. The interchangeable covering system according to embodiments 1-13, wherein a first one of the side brackets provides a disconnect sleeve removably insertable within a first end of the roller tube, thereby allowing the roller tube to be removably engaged with the first one of the side brackets.

15. The interchangeable covering system according to embodiments 1-14, wherein an outer surface of the disconnect sleeve is configured for being frictionally engaged within the first end of the roller tube.

16. The interchangeable covering system according to embodiments 1-15, wherein the outer surface of the disconnect sleeve provides an elongated alignment slot positioned and configured for slidably receiving a length of the alignment rail on the inner surface of the roller tube, thereby allowing the disconnect sleeve and the roller tube to rotate in unison relative to the side brackets.

17. The interchangeable covering system according to embodiments 1-16, wherein the disconnect sleeve provides a release button positioned and configured for disengaging the disconnect sleeve from the first end of the roller tube.

18. The interchangeable covering system according to embodiments 1-17, wherein the disconnect sleeve defines an interior space sized and configured for receiving a release spring therewithin.

19. The interchangeable covering system according to embodiments 1-18, wherein the interior space of the disconnect sleeve is further sized and configured for receiving a brake mechanism, such that the release spring is held within the interior space by the brake mechanism, the brake mechanism positioned and configured for rotationally locking the roller tube relative to the side brackets.

20. The interchangeable covering system according to embodiments 1-19, wherein the brake mechanism is keyed for mating with an inner surface of the disconnect sleeve, thereby allowing the brake mechanism and the disconnect sleeve to rotate in unison.

21. The interchangeable covering system according to embodiments 1-20, wherein the brake mechanism provides a locking ring configured for selectively retaining the brake mechanism within the disconnect sleeve.

22. The interchangeable covering system according to embodiments 1-21, wherein the brake mechanism provides a bracket slot positioned and configured for removably receiving a corresponding bracket tab provided by the first one of the side brackets.

23. The interchangeable covering system according to embodiments 1-22, wherein a second one of the side brackets provides a drive assembly engaged with an opposing second end of the roller tube and configured for rotating the roller tube.

24. The interchangeable covering system according to embodiments 1-23, wherein a first end of the drive assembly provides a bracket slot positioned and configured for removably receiving a corresponding bracket tab provided by the second one of the side brackets.

25. The interchangeable covering system according to embodiments 1-24, wherein an opposing second end of the drive assembly provides an elongated alignment slot positioned and configured for slidably receiving a length of the alignment rail on the inner surface of the roller tube, thereby allowing the drive assembly and the roller tube to rotate in unison relative to the side brackets.

26. The interchangeable covering system according to embodiments 1-25, wherein the drive assembly is a spring drive assembly configured for rotating the roller tube in a direction so as to roll the panel up onto the roller tube.

27. The interchangeable covering system according to embodiments 1-26, wherein the drive assembly is a motor assembly configured for rotating the roller tube in a desired direction.

28. The interchangeable covering system according to embodiments 1-27, wherein: the mounting bar is configured as a cassette providing a cassette casing sized for housing the motor assembly; the pair of side brackets are configured as a pair of cassette end panels, each of the cassette end panels providing an at least one mounting tab positioned and configured for being slidably engaged with a corresponding mounting slot provided by the cassette casing; and opposing ends of the motor assembly each provides a bracket slot positioned and configured for removably receiving a corresponding end panel tab provided by each of the cassette end panels.

29. The interchangeable covering system according to embodiments 1-28, wherein: the attachment strip provides an at least one roller clip; and the top edge of the panel provides a corresponding at least one panel clip positioned and configured for removable engagement with the at least one roller clip.

30. The interchangeable covering system according to embodiments 1-29, wherein: the bottom edge of the panel provides an at least one edge tab; and the panel rail provides a lengthwise rail slot extending an entire length of the panel rail, the rail slot providing a pair of opposing open terminal ends positioned at opposing ends of the panel rail and configured for slidably receiving the at least one edge tab into the rail slot.

31. The interchangeable covering system according to embodiments 1-30, wherein the panel rail further provides a pair of end caps removably engagable with the opposing ends of the panel rail, each end cap configured for obstructing the corresponding one of the terminal ends of the rail slot so as to prevent the at least one edge tab from unintentional disengagement from the rail slot.

32. An interchangeable covering system positionable for selectively covering an opening in a substantially vertically oriented surface, the system comprising: a pair of side brackets positionable on either the opening or the surface proximal to the opening; a roller tube rotatably and removably engagable between the side brackets, an outer surface of the roller tube defining an elongated, recessed attachment strip extending an entire length of the roller tube, the attachment strip forming an elongated alignment rail on an opposing inner surface of the roller tube and extending an entire length thereof; an at least one flexible panel sized for covering the opening, a top edge of the panel removably engagable with the attachment strip of the roller tube such that the top edge of the panel sits substantially flush with the outer surface of the roller tube; a first one of the side brackets providing a disconnect sleeve removably insertable within a first end of the roller tube, an outer surface of the disconnect sleeve providing an elongated alignment slot positioned and configured for slidably receiving a length of the alignment rail of the roller tube, thereby allowing the disconnect sleeve and the roller tube to rotate in unison relative to the side brackets; a second one of the side brackets providing a drive assembly engaged with an opposing second end of the roller tube and configured for rotating the roller tube, an outer surface of the drive assembly providing an elongated alignment slot positioned and configured for slidably receiving a length of the alignment rail of the roller tube, thereby allowing the drive assembly and the roller tube to rotate in unison relative to the side brackets; and a panel rail engaged with an opposing bottom edge of the panel; whereby, the system is capable of facilitating the easy swapping of one panel for another.

33. An interchangeable covering system positionable for selectively covering an opening in a substantially vertically oriented surface, the system comprising: an at least one flexible panel sized for covering the opening; a first panel rail removably engagable with a top edge of the panel and configured for being mounted on either the opening or the surface proximal to the opening; a second panel rail engaged with an opposing bottom edge of the panel; the first panel rail providing an at least one first attachment portion positioned and configured for removable engagement with a corresponding at least one second attachment portion provided by the second panel rail, wherein upon the second panel rail being folded up against the first panel rail, the first and second attachment portions removably secure the first and second panel rails together; whereby, the system is capable of facilitating the easy swapping of one panel for another.

34. The interchangeable covering system according to embodiment 33, wherein the at least one panel is constructed out of at least one of paper, plastic, vinyl, rubber, fabric, metal, and privacy mesh.

35. The interchangeable covering system according to embodiments 33-34, wherein: the top edge of the panel provides an at least one edge tab; the first panel rail provides a lengthwise rail slot extending an entire length of the first panel rail, the rail slot providing a pair of opposing open terminal ends positioned at opposing ends of the first panel rail and configured for slidably receiving the at least one edge tab of the top edge of the panel into the rail slot; the bottom edge of the panel provides an at least one edge tab; and the second panel rail provides a lengthwise rail slot extending an entire length of the second panel rail, the rail slot providing a pair of opposing open terminal ends positioned at opposing ends of the second panel rail and configured for slidably receiving the at least one edge tab of the bottom edge of the panel into the rail slot.

36. The interchangeable covering system according to embodiments 33-35, wherein: the first panel rail further provides a pair of end caps removably engagable with the opposing ends of the first panel rail, each end cap configured for obstructing the corresponding one of the terminal ends of the rail slot of the first panel rail so as to prevent the at least one edge tab of the top edge of the panel from unintentional disengagement from said rail slot; and the second panel rail further provides a pair of end caps removably engagable with the opposing ends of the second panel rail, each end cap configured for obstructing the corresponding one of the terminal ends of the rail slot of the second panel rail so as to prevent the at least one edge tab of the bottom edge of the panel from unintentional disengagement from said rail slot.

37. The interchangeable covering system according to embodiments 33-36, wherein: each of the pair of end caps of the first panel rail provide a first attachment portion; and each of the pair of end caps of the second panel rail provide a second attachment portion.

38. The interchangeable covering system according to embodiments 33-37, wherein each of the pair of end caps of the first panel rail provides an at least one end cap mounting hole extending substantially transversely through said end cap for allowing a fastener to extend therethrough and into the surface, thereby securing each of the end caps of the first panel to the surface.

39. The interchangeable covering system according to embodiments 33-38, further comprising an at least one mounting bracket engaged with the first panel rail and configured for securing the first panel rail to the surface, each of the at least one mounting bracket comprising: a mounting portion providing an at least one engagement tab positioned and configured for removable engagement with a corresponding at least one engagement receptacle positioned on a rear surface of the first panel rail; and a backplate providing a recess sized and configured for removably receiving the mounting portion therewithin, the backplate configured for being secured to the surface via an at least one fastener.

40. The interchangeable covering system according to embodiments 33-39, wherein the at least one engagement receptacle is an aperture positioned and configured for receiving the corresponding at least one engagement tab therethrough.

41. The interchangeable covering system according to embodiments 33-40, wherein the at least one engagement receptacle is a slot positioned and configured for receiving the corresponding at least one engagement tab therewithin.

42. The interchangeable covering system according to embodiments 33-41, wherein the backplate of the at least one mounting bracket further provides: an at least one primary mounting hole positioned substantially at a center point of the backplate and extending through the backplate for allowing the at least one fastener to extend therethrough and into the surface, thereby securing the backplate to the surface; and an at least one secondary mounting hole positioned for further securing the backplate to the surface, the at least one secondary mounting hold extending through the backplate for allowing a further at least one fastener to extend therethrough and into the surface; whereby, the backplate is first secured to the surface via the at least one primary mounting hole so as to enable the backplate to be leveled prior to further securing the backplate to the surface via the at least one secondary mounting hole.

43. The interchangeable covering system according to embodiments 33-42, wherein the mounting portion provides a corresponding at least one engagement hole positioned and configured for aligning with the at least one primary mounting hole when the mounting portion is engaged with the backplate, thereby allowing the corresponding at least one fastener to extend through each of the engagement hole and primary mounting hole when securing the backplate to the surface.

44. The interchangeable covering system according to embodiments 33-43, wherein a rear surface of the backplate provides an at least one temporary fastener pad positioned and configured for temporarily securing the backplate to the surface after the backplate has been leveled, prior to being secured via the at least one secondary mounting hole.

45. The interchangeable covering system according to embodiments 33-44, wherein: the mounting portion is frictionally engagable with the recess; and the mounting portion further provides a release tab positioned and configured for assisting in manually disengaging the mounting portion from the recess.

46. The interchangeable covering system according to embodiments 33-45, further comprising a release tool configured for assisting in accessing and manually actuating the release tab, the release tool comprising: an elongated handle portion; and a tab release notch positioned at a distal end of the handle portion, the tab release notch sized for approximating the dimensions of the release tab; whereby, in use, with the tab release notch positioned between the release tab and the surface on which the mounting bracket is secured, an opposing proximal end of the handle portion is pivoted toward the surface, thereby causing the tab release notch to contact the release tab and disengage the mounting portion from the recess of the backplate.

47. The interchangeable covering system according to embodiments 33-46, wherein the second panel rail is configured for being removably engaged with either the opening or the surface proximal to the opening.

48. The interchangeable covering system according to embodiments 33-47, wherein: the first panel rail is constructed out of an at least one mounting strip engaged with the top edge of the panel; and the second panel rail is constructed out of an at least one mounting strip engaged with the bottom edge of the panel.

In closing, regarding the exemplary embodiments of the present invention as shown and described herein, it will be appreciated that an interchangeable opening covering system and associated methods of use and manufacture are disclosed and configured for the easy insertion, exchange, and control of associated window and/or door covering materials to accommodate the needs of various openings and applications. Because the principles of the invention may be practiced in a number of configurations beyond those shown and described, it is to be understood that the invention is not in any way limited by the exemplary embodiments, but is generally directed to an interchangeable opening covering system and is able to take numerous forms to do so without departing from the spirit and scope of the invention. It will also be appreciated by those skilled in the art that the present invention is not limited to the particular geometries and materials of construction disclosed, but may instead entail other functionally comparable structures or materials, now known or later developed, without departing from the spirit and scope of the invention.

Certain embodiments of the present invention are described herein, including the best mode known to the inventor(s) for carrying out the invention. Of course, variations on these described embodiments will become apparent to those of ordinary skill in the art upon reading the foregoing description. The inventor(s) expect skilled artisans to employ such variations as appropriate, and the inventor(s) intend for the present invention to be practiced otherwise than specifically described herein. Accordingly, this invention includes all modifications and equivalents of the subject matter recited in the claims appended hereto as permitted by applicable law. Moreover, any combination of the above-described embodiments in all possible variations thereof is encompassed by the invention unless otherwise indicated herein or otherwise clearly contradicted by context.

Groupings of alternative embodiments, elements, or steps of the present invention are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. At the very least, and not as an attempt to limit the application of the doctrine of equivalents to the scope of the claims, each numerical indication should at least be construed in light of the number of reported significant digits and by applying ordinary rounding techniques. Notwithstanding that the numerical ranges and values setting forth the broad scope of the invention are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein. Similarly, as used herein, unless indicated to the contrary, the term “substantially” is a term of degree intended to indicate an approximation of the characteristic, item, quantity, parameter, property, or term so qualified, encompassing a range that can be understood and construed by those of ordinary skill in the art.

Use of the terms “may” or “can” in reference to an embodiment or aspect of an embodiment also carries with it the alternative meaning of “may not” or “cannot.” As such, if the present specification discloses that an embodiment or an aspect of an embodiment may be or can be included as part of the inventive subject matter, then the negative limitation or exclusionary proviso is also explicitly meant, meaning that an embodiment or an aspect of an embodiment may not be or cannot be included as part of the inventive subject matter. In a similar manner, use of the term “optionally” in reference to an embodiment or aspect of an embodiment means that such embodiment or aspect of the embodiment may be included as part of the inventive subject matter or may not be included as part of the inventive subject matter. Whether such a negative limitation or exclusionary proviso applies will be based on whether the negative limitation or exclusionary proviso is recited in the claimed subject matter.

The terms “a,” “an,” “the” and similar references used in the context of describing the present invention (especially in the context of the following claims) are to be construed to cover both the singular and the plural, unless otherwise indicated herein or clearly contradicted by context. Further, ordinal indicators—such as “first,” “second,” “third,” etc.—for identified elements are used to distinguish between the elements, and do not indicate or imply a required or limited number of such elements, and do not indicate a particular position or order of such elements unless otherwise specifically stated. All methods described herein can be performed in any suitable order unless otherwise indicated herein or otherwise clearly contradicted by context. The use of any and all examples, or exemplary language (e.g., “such as”) provided herein is intended merely to better illuminate the present invention and does not pose a limitation on the scope of the invention otherwise claimed. No language in the present specification should be construed as indicating any non-claimed element essential to the practice of the invention.

When used in the claims, whether as filed or added per amendment, the open-ended transitional term “comprising” (along with equivalent open-ended transitional phrases thereof such as “including,” “containing” and “having”) encompasses all the expressly recited elements, limitations, steps and/or features alone or in combination with un-recited subject matter; the named elements, limitations and/or features are essential, but other unnamed elements, limitations and/or features may be added and still form a construct within the scope of the claim. Specific embodiments disclosed herein may be further limited in the claims using the closed-ended transitional phrases “consisting of” or “consisting essentially of” in lieu of or as an amendment for “comprising.” When used in the claims, whether as filed or added per amendment, the closed-ended transitional phrase “consisting of” excludes any element, limitation, step, or feature not expressly recited in the claims. The closed-ended transitional phrase “consisting essentially of” limits the scope of a claim to the expressly recited elements, limitations, steps and/or features and any other elements, limitations, steps and/or features that do not materially affect the basic and novel characteristic(s) of the claimed subject matter. Thus, the meaning of the open-ended transitional phrase “comprising” is being defined as encompassing all the specifically recited elements, limitations, steps and/or features as well as any optional, additional unspecified ones. The meaning of the closed-ended transitional phrase “consisting of” is being defined as only including those elements, limitations, steps and/or features specifically recited in the claim, whereas the meaning of the closed-ended transitional phrase “consisting essentially of” is being defined as only including those elements, limitations, steps and/or features specifically recited in the claim and those elements, limitations, steps and/or features that do not materially affect the basic and novel characteristic(s) of the claimed subject matter. Therefore, the open-ended transitional phrase “comprising” (along with equivalent open-ended transitional phrases thereof) includes within its meaning, as a limiting case, claimed subject matter specified by the closed-ended transitional phrases “consisting of” or “consisting essentially of.” As such, embodiments described herein or so claimed with the phrase “comprising” are expressly or inherently unambiguously described, enabled and supported herein for the phrases “consisting essentially of” and “consisting of.”

Any claims intended to be treated under 35 U.S.C. § 112(f) will begin with the words “means for,” but use of the term “for” in any other context is not intended to invoke treatment under 35 U.S.C. § 112(f). Accordingly, Applicant reserves the right to pursue additional claims after filing this application, in either this application or in a continuing application.

It should be understood that the methods and the order in which the respective elements of each method are performed are purely exemplary. Depending on the implementation, they may be performed in any order or in parallel, unless indicated otherwise in the present disclosure.

All patents, patent publications, and other publications referenced and identified in the present specification are individually and expressly incorporated herein by reference in their entirety for the purpose of describing and disclosing, for example, the compositions and methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

While aspects of the invention have been described with reference to at least one exemplary embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. An interchangeable covering system positionable for selectively covering an opening in a substantially vertically oriented surface, the system comprising:
a pair of side brackets positionable on either the opening or the surface proximal to the opening;
a roller tube rotatably and removably engagable between the side brackets, an outer surface of the roller tube defining an elongated, recessed attachment strip extending an entire length of the roller tube;
an at least one flexible panel sized for covering the opening, a top edge of the panel removably engagable with the attachment strip of the roller tube such that the top edge of the panel sits substantially flush with the outer surface of the roller tube; and
a panel rail engaged with an opposing bottom edge of the panel;
whereby, the system is capable of facilitating the easy swapping of one panel for another.

2. The interchangeable covering system of claim 1, wherein the attachment strip forms an elongated alignment rail on an opposing inner surface of the roller tube, the alignment rail extending the entire length of the roller tube.

3. The interchangeable covering system of claim 1, wherein the side brackets are configured for being removably engagable with opposing ends of a substantially horizontally oriented mounting bar, the mounting bar configured for being mounted on either the opening or the surface proximal to the opening in a substantially horizontal orientation.

4. The interchangeable covering system of claim 3, further comprising an at least one mounting bracket engaged with the mounting bar and configured for securing the mounting bar to the surface, each of the at least one mounting bracket comprising:
a mounting portion providing an at least one engagement tab positioned and configured for removable engagement with a corresponding at least one engagement receptacle positioned on a rear surface of the mounting bar; and
a backplate providing a recess sized and configured for removably receiving the mounting portion therewithin, the backplate configured for being secured to the surface via an at least one fastener.

5. The interchangeable covering system of claim 4, wherein the backplate of the at least one mounting bracket further provides:
an at least one primary mounting hole positioned substantially at a center point of the backplate and extending through the backplate for allowing the at least one fastener to extend therethrough and into the surface, thereby securing the backplate to the surface; and
an at least one secondary mounting hole positioned for further securing the backplate to the surface, the at least one secondary mounting hold extending through the backplate for allowing a further at least one fastener to extend therethrough and into the surface;
whereby, the backplate is first secured to the surface via the at least one primary mounting hole so as to enable the backplate to be leveled prior to further securing the backplate to the surface via the at least one secondary mounting hole.

6. The interchangeable covering system of claim 2, wherein a first one of the side brackets provides a disconnect sleeve removably insertable within a first end of the roller tube, thereby allowing the roller tube to be removably engaged with the first one of the side brackets.

7. The interchangeable covering system of claim 6, wherein an outer surface of the disconnect sleeve provides an elongated alignment slot positioned and configured for slidably receiving a length of the alignment rail on the inner surface of the roller tube, thereby allowing the disconnect sleeve and the roller tube to rotate in unison relative to the side brackets.

8. The interchangeable covering system of claim 7, wherein the interior space of the disconnect sleeve is further sized and configured for receiving a brake mechanism, such that the release spring is held within the interior space by the brake mechanism, the brake mechanism positioned and configured for rotationally locking the roller tube relative to the side brackets.

9. The interchangeable covering system of claim 8, wherein the brake mechanism is keyed for mating with an inner surface of the disconnect sleeve, thereby allowing the brake mechanism and the disconnect sleeve to rotate in unison.

10. The interchangeable covering system of claim 8, wherein the brake mechanism provides a bracket slot positioned and configured for removably receiving a corresponding bracket tab provided by the first one of the side brackets.

11. The interchangeable covering system of claim 6, wherein a second one of the side brackets provides a drive assembly engaged with an opposing second end of the roller tube and configured for rotating the roller tube.

12. The interchangeable covering system of claim 11, wherein a first end of the drive assembly provides a bracket slot positioned and configured for removably receiving a corresponding bracket tab provided by the second one of the side brackets.

13. The interchangeable covering system of claim 12, wherein an opposing second end of the drive assembly provides an elongated alignment slot positioned and configured for slidably receiving a length of the alignment rail on the inner surface of the roller tube, thereby allowing the drive assembly and the roller tube to rotate in unison relative to the side brackets.

14. The interchangeable covering system of claim 1, wherein:
the bottom edge of the panel provides an at least one edge tab; and
the panel rail provides a lengthwise rail slot extending an entire length of the panel rail, the rail slot providing a pair of opposing open terminal ends positioned at opposing ends of the panel rail and configured for slidably receiving the at least one edge tab into the rail slot.

15. The interchangeable covering system of claim 14, wherein the panel rail further provides a pair of end caps removably engagable with the opposing ends of the panel rail, each end cap configured for obstructing the corresponding one of the terminal ends of the rail slot so as to prevent the at least one edge tab from unintentional disengagement from the rail slot.

16. An interchangeable covering system positionable for selectively covering an opening in a substantially vertically oriented surface, the system comprising:
a pair of side brackets positionable on either the opening or the surface proximal to the opening;
a roller tube rotatably and removably engagable between the side brackets, an outer surface of the roller tube defining an elongated, recessed attachment strip extending an entire length of the roller tube, the attachment strip forming an elongated alignment rail on an opposing inner surface of the roller tube and extending an entire length thereof;
an at least one flexible panel sized for covering the opening, a top edge of the panel removably engagable with the attachment strip of the roller tube such that the top edge of the panel sits substantially flush with the outer surface of the roller tube;
a first one of the side brackets providing a disconnect sleeve removably insertable within a first end of the roller tube, an outer surface of the disconnect sleeve providing an elongated alignment slot positioned and configured for slidably receiving a length of the alignment rail of the roller tube, thereby allowing the disconnect sleeve and the roller tube to rotate in unison relative to the side brackets;
a second one of the side brackets providing a drive assembly engaged with an opposing second end of the roller tube and configured for rotating the roller tube, an outer surface of the drive assembly providing an elongated alignment slot positioned and configured for slidably receiving a length of the alignment rail of the roller tube, thereby allowing the drive assembly and the roller tube to rotate in unison relative to the side brackets; and
a panel rail engaged with an opposing bottom edge of the panel;
whereby, the system is capable of facilitating the easy swapping of one panel for another.

17. An interchangeable covering system positionable for selectively covering an opening in a substantially vertically oriented surface, the system comprising:
an at least one flexible panel sized for covering the opening;
a first panel rail removably engagable with a top edge of the panel and configured for being mounted on either the opening or the surface proximal to the opening;
a second panel rail engaged with an opposing bottom edge of the panel; and
the first panel rail providing an at least one first attachment portion positioned and configured for removable engagement with a corresponding at least one second attachment portion provided by the second panel rail, wherein upon the second panel rail being folded up against the first panel rail, the first and second attachment portions removably secure the first and second panel rails together;
whereby, the system is capable of facilitating the easy swapping of one panel for another.

18. The interchangeable covering system of claim 17, wherein:
the top edge of the panel provides an at least one edge tab;
the first panel rail provides a lengthwise rail slot extending an entire length of the first panel rail, the rail slot providing a pair of opposing open terminal ends positioned at opposing ends of the first panel rail and configured for slidably receiving the at least one edge tab of the top edge of the panel into the rail slot;
the bottom edge of the panel provides an at least one edge tab; and
the second panel rail provides a lengthwise rail slot extending an entire length of the second panel rail, the rail slot providing a pair of opposing open terminal ends positioned at opposing ends of the second panel rail and configured for slidably receiving the at least one edge tab of the bottom edge of the panel into the rail slot.

19. The interchangeable covering system of claim 18, wherein:
the first panel rail further provides a pair of end caps removably engagable with the opposing ends of the first panel rail, each end cap configured for obstructing the corresponding one of the terminal ends of the rail slot of the first panel rail so as to prevent the at least one edge tab of the top edge of the panel from unintentional disengagement from said rail slot; and
the second panel rail further provides a pair of end caps removably engagable with the opposing ends of the second panel rail, each end cap configured for obstructing the corresponding one of the terminal ends of the rail slot of the second panel rail so as to prevent the at least one edge tab of the bottom edge of the panel from unintentional disengagement from said rail slot.

20. The interchangeable covering system of claim 17, wherein:
the first panel rail is constructed out of an at least one mounting strip engaged with the top edge of the panel; and
the second panel rail is constructed out of an at least one mounting strip engaged with the bottom edge of the panel.
